(19) United States
(12) Patent Application Publication
(10) Pub. No.: US 2014/0129843 A1
(43) Pub. Date: May 8, 2014

(54) Methods and Apparatus for Managing Service Access Using a Touch-Display Device Integrated with Fingerprint Imager

(71) Applicants: Weidong Shi, Pearland, TX (US); Tao Feng, Houston, TX (US); Yang Lu, Houston, TX (US)

(72) Inventors: Weidong Shi, Pearland, TX (US); Tao Feng, Houston, TX (US); Yang Lu, Houston, TX (US)

(21) Appl. No.: 13/667,235

(22) Filed: Nov. 2, 2012

(51) Int. Cl. G06F 21/32

(52) U.S. Cl. CPC G06F 21/32
USPC 713/182

(57) ABSTRACT

The present invention with an apparatus enables biometric based access control to services and/or resources that comprises a crypto processor, a biometric processor, a fingerprint controller, a frame hash engine, a display repeater and/or a display controller, a touch-panel controller and a biometric touch-display panel. The frame hash engine and/or the display controller computes a frame hash of the frame displayed on the biometric touch-display panel. When a fingerprint is captured, in the registration scenario, the biometric processor extracts biometric identity and stores it in a service biometric credential repository identity, and submits a registration proof to the server; in the service access scenarios, the biometric processor verifies user identity by matching fingerprint, and submits an access identity to the server.

### BACKGROUND OF THE INVENTION

### Field of the Invention

This invention relates to designing a biometric touch-display apparatus that comprises a crypto processor, a biometric processor, a fingerprint controller, a display repeater and/or a display controller, and a touch-panel controller for supporting identity management and/or access control to services and/or resources.

### BRIEF DESCRIPTION OF THE DRAWINGS

The invention may be better understood, and further advantages and uses thereof more readily apparent, when considered in view of the following detailed description of exemplary embodiments and examples, taken with the accompanying diagrams, in which:

FIG. 1(A) is a block diagram showing, in one exemplary embodiment of the present invention, the components involved for implementing a biometric touch-display apparatus;

FIG. 1(B) is a block diagram showing, in another exemplary embodiment of the present invention, the components involved for implementing a biometric touch-display apparatus;

FIG. 2 is a block diagram showing, in one exemplary embodiment of the present invention, the components involved for implementing a biometric touch-display panel;

FIG. 3(A), is a block diagram showing, in one exemplary embodiments of the present invention, the structure of fingerprint imager, display, and touch panel;

FIG. 3(B), is a block diagram showing, in another exemplary embodiments of the present invention, the structure of fingerprint imager, display, and touch panel;

FIG. 3(C), is a block diagram showing, in another exemplary embodiments of the present invention, the structure of fingerprint imager, display, and touch panel;

FIG. 3(D), is a block diagram showing, in another exemplary embodiments of the present invention, the structure of fingerprint imager, display, and touch panel;

FIG. 3(E), is a block diagram showing, in another exemplary embodiments of the present invention, the structure of fingerprint imager, display, and touch panel;

FIG. 4(A) is a block diagram showing, in one exemplary embodiments of the present invention, the components involved for supporting identity management by a computing system;

FIG. 4(B) is a block diagram showing, in another exemplary embodiments of the present invention, the components involved for supporting identity management by a computing system;

FIG. 5 is a block diagram showing, in one exemplary embodiment of the present invention, the system involved for identity based service context management;

FIG. 6 is a flowchart showing, in one exemplary embodiment of the present invention, the process involved for associating fingerprint with the service access credential by using a biometric touch-display apparatus;

FIG. 7 is a flowchart showing, in one exemplary embodiment of the present invention, the process of creating a session when a service is accessed using a bio-metric touch-display apparatus; and

FIG. 8 is a flowchart showing, in one exemplary embodiment of the present invention, the process of continuous identity management during access of service contents.

While the patent invention shall now be described with reference to the embodiments shown in the drawings, it should be understood that the intention is not to limit the invention only to the particular embodiments shown but rather to cover alterations, modifications and equivalent arrangements possible within the scope of appended claims. Throughout this discussion that follows, it should be understood that the terms are used in the functional sense and not exclusively with reference to specific embodiment, implementation, programming interface.

### DETAILED DESCRIPTION OF THE PREFERRED EMBODIMENTS

Discussion in this section is intended to provide a brief description of some exemplary embodiments of the present invention.

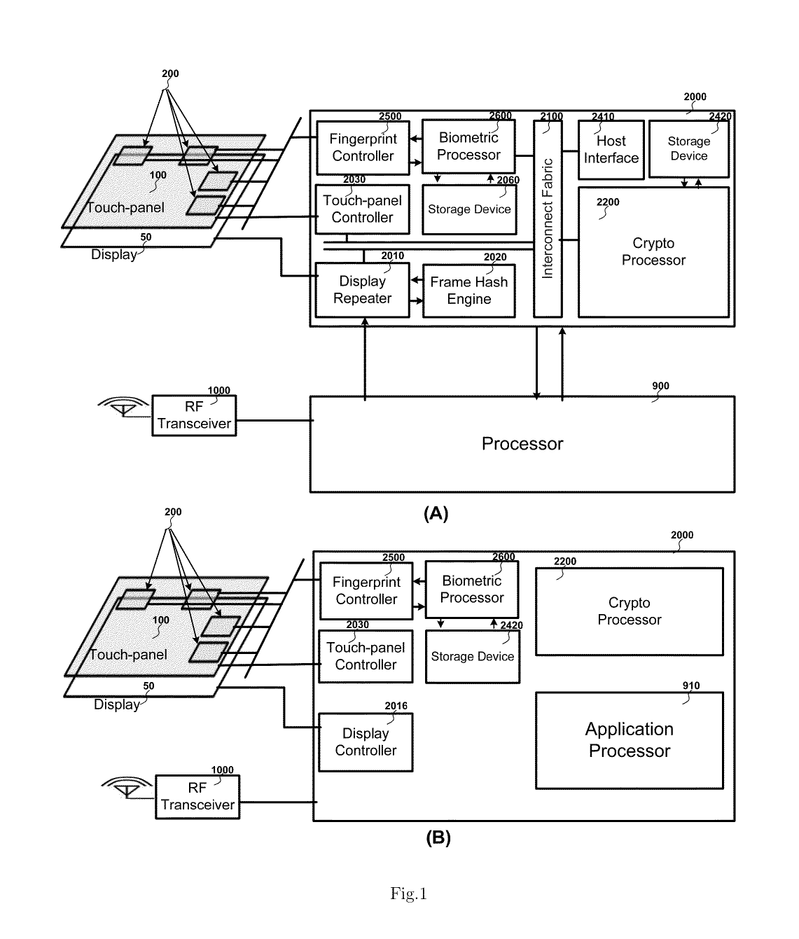

FIG. 1(A) is a block diagram showing, in one exemplary embodiment of the present invention, the components involved for implementing a biometric touch-display apparatus.

In one exemplary embodiment, a biometric touch-display apparatus (2000) can comprise a crypto processor (2200), a biometric processor (2600), a display repeater (2010) and/or a display controller coupled with an electronic display device (50), one interconnect fabric (2100), one or multiple electronic storage devices (2420), and a touch-panel controller (2030). The biometric touch-display apparatus can couple with a processor (900). A processor is an electronic circuit which executes computer programs. A computing system (e.g., laptop, desktop, tablet, notebook, PDA, mobile Internet device, mobile phone, handheld gaming device, Kiosk) can comprise one or multiple processors. A computing system can comprise one or multiple biometric touch-display apparatuses.

In further embodiments, a processor (900) can be implemented as system on a chip (SoC). A system on a chip or system on chip (SoC or SOC) is an integrated circuit (IC) that integrates components of a computer or other electronic system into a single chip. It may contain digital, or analog, or mixed-signal, or radio-frequency functions all on a single chip substrate. Sometimes, a SoC processor designed for supporting applications executed by a mobile computing system (e.g., tablet, mobile phone, mobile Internet device, handheld gaming device, PDA) is called application processor (910).

A crypto processor (2200) is a component for carrying out cryptography and/or security operations. Depending on the implementation, a crypto processor can provide support for creating public-private key pair (e.g., DiffieHellman key exchange protocol, DSS, ElGamal, Various elliptic curve techniques, Paillier crypto schemes, RSA encryption approaches, CramerShoup crypto schemes), or verifying electronic certificates, or signing digital signatures (e.g., RSA based signature, DSA based signature, elliptic curve based DSA, ElGamal signature, Rabin signature approach, Pairing based signature scheme, undeniable signature, aggregate signature), or computing message authentication codes for digital data, or performing mutual authentications, or carrying out symmetric key encryption (e.g., Twofish, Serpent, AES, Blowfish, CAST5, RC4, 3DES, IDEA), or performing digital hash functions (e.g., Gost, Haval, MD5, Panama, Ripemd, SHA-1, SHA-256, SHA-512, SHA-3, Whirlpool), etc.

A biometric processor (2600) is a component used for enrolling and/or matching fingerprints. A captured fingerprint image can be digitally processed by the biometric processor to create a biometric template (a collection of extracted features) that is stored in a storage device (2060) and used for matching.

An electronic display device (50) is an output device for presentation of information in visual form (e.g., OLED displays, liquid crystal display devices such as TFT-LCD, electronic paper display, Interferometric modulator display, Electro-wetting display). Depending on the implementations, a display can be made using transparent components (e.g., transparent OLED). Furthermore, an embodiment can integrate touch sensing circuitry and display together (e.g., touch-display panel, in-cell touch-display panel).

A display repeater (2010) is a component that receives display output from a processor (900). In an embodiment, a display repeater can intercept display output and transmit it to a display device (50). Depending on the implementations, the display interface between the processor and the display repeater includes but not limited to, LCD, LVDS (Low-voltage differential signaling), serial data link, etc.

An interconnect fabric is a component which lets the parts of an integrated circuit communicate with each other. It allows the connection of differing components to each other inside of a chip (e.g., AMBA, CoreConnect, WISHBONE). A host interface (2410) is a component that supports communication between a host processor (900) and the biometric touch-display apparatus. In an embodiment, a host processor can send request to and/or receive response from a biometric touch-display apparatus.

An electronic storage device (2060 or 2420) is any medium that can be used to record information electronically. In an embodiment, an electronic storage device can be non-volatile computer storage. A non-volatile computer storage is random-access memory that retains its information when power is turned off (non-volatile), it can be on-chip (e.g., Non-volatile SRAMs, on-chip flash memory) or off-chip (e.g., Flash memory, Ferroelectric RAM, Magnetoresistive random-access memory, Phase-change memory, Nano-RAM, Millipede memory, Resistive random-access memory). In an embodiment, a biometric touch-display apparatus can store fingerprint templates in a non-volatile computer storage. Furthermore, in additional embodiments, a biometric touch-display apparatus can store a collection of service biometric credential records in a non-volatile computer storage.

A touch-panel controller (2030) is a component that can determine the location of the touch from a touch panel (100). A touch panel is a device that can detect the presence and location of a touch (e.g., capacitive touch panel, resistive touch panel, acoustic wave touch panel, infrared touch panel, projective capacitive touch panel, etc).

Furthermore, in an embodiment, a biometric touch-display apparatus can further comprise at least one frame hash engine (2020) coupled with the display repeater (2010) and/or display controller. A hash function, (e.g., cyclic redundancy checks, checksum functions, and cryptographic hash functions), is any algorithm or subroutine that maps large data sets of variable or constant length to smaller data sets of a fixed length. For example, a string with a variable or constant length could be hashed to a single integer. The values returned by a hash function are called hash values, or hash codes, or hash sums, or checksums, or simply hashes. A frame hash engine (2020) is a device that can compute a hash from pixel values of a frame displayed by the biometric touch-display apparatus. Depending on the implementations, a frame can be rendered by a GPU (graphical processing unit) or a display controller (2016).

In an additional embodiment, a biometric touch-display apparatus can further comprise at least one fingerprint controller (2500) coupled with at least one or a plurality of fingerprint imagers (200). The fingerprint controller (2500) can read inputs from the coupled fingerprint imager (200) or fingerprint imagers. In further embodiments, a fingerprint controller (2500) can be coupled with a biometric processor (2600). Captured fingerprint data can be transmitted from the fingerprint controller (2500) to the biometric processor (2600).

A fingerprint imager (200) is an electronic device used to capture a digital image of the fingerprint pattern. The captured image can be digitally processed to create a biometric template (a collection of extracted features) that is stored and used for matching. Fingerprint imagers (200) include but not limited to optical fingerprint imagers, ultrasonic fingerprint imagers, thermal fingerprint imagers, capacitance fingerprint imagers, passive capacitance fingerprint imagers, MEMS based fingerprint imager, optical fingerprint imager, Nano-based fingerprint imager (e.g., nano tubes, nano wires), and active capacitance fingerprint imagers.

Depending on the implementations, a fingerprint controller (2500) can select and/or activate a fingerprint imager according to pre-determined conditions. In one embodiment, when finger tip is inside the region covered by a fingerprint imager, its location will be recorded. Then the controller (2500) will select and activate one or multiple fingerprint imagers to capture one or multiple fingerprints according to their locations.

In an additional embodiment, a biometric touch-display apparatus can further comprise at least one biometric touch-display panel (2000) coupled with the touch-panel controller (2030), display repeater (2010) and/or display controller, and fingerprint controller (2500). The biometric touch-display panel comprises at least one or a plurality of fingerprint imagers. The fingerprint imager or fingerprint imagers are integrated with a touch-display panel or a touch-panel. A biometric touch-display panel is a device that integrates a touch panel, a display, one or multiple fingerprint imagers.

In one embodiment, a fingerprint controller (2500), a display repeater (2010), a frame hash engine (2020), a touch-panel controller (2030), an interconnect fabric (2100), a crypto-processor (2200), a biometric processor (2600), a host interface (2410) are integrated into one computer chip (e.g., a single silicon chip, system-on-chip, system-in-a-package). The computer chip can control a touch-panel (100), a display (50), one or multiple fingerprint imagers (200). It can couple with a host processor using the host interface (2410).

Furthermore, in an embodiment, the components of a biometric touch-display apparatus can be contained in a computing system (e.g., laptop, desktop, tablet, notebook, PDA, mobile phone, mobile Internet device, handheld gaming device, Kiosk). Depending on the implementations, the computing system can comprise one or multiple transceivers.

A transceiver (e.g, RF transceiver, Ethernet transceiver) is a device comprising both transmitter and receiver handling circuitry. The RF Transceiver uses RF (radio frequency) modules for data transmission.

FIG. 1(B) is a block diagram showing, in another exemplary embodiment of the present invention, the components involved for implementing a biometric touch-display apparatus.

In an embodiment, the components of a biometric touch-display apparatus can be integrated with other logical units (e.g., application processor 910) for building a computing system. For example, in one embodiment, a SoC (system on a chip) or a SIP (system in a package) system can comprise an application processor (910), a display controller (2016), a fingerprint controller (2500), a biometric processor (2600), and a crypto-processor (2200). In additional embodiments, the touch-panel controller can also be integrated (2030) with the SoC or SIP system.

In other embodiments, the components of a biometric touch-display apparatus can be integrated by a computing system. For example, in one implementation, a computing system can comprise, one biometric touch-display panel (2000) coupled with a touch-panel controller (2030), a display controller (2016), and a fingerprint controller (2500). In further embodiments, the computing system can comprise, a biometric processor (2600), a crypto-processor (2200), an application processor (910), one or multiple transceivers.

Furthermore, in an embodiment, a frame hash engine (2020) can be integrated with a display controller (2016). Depending on the implementations, the frame hash engine and the display controller can be on the same SoC or the same SIP.

Moreover, in an embodiment, a fingerprint controller (2500) and a touch-panel controller (2030) can be integrated into one component that controls both a touch-panel and one or multiple fingerprint imagers.

In an embodiment, a biometric touch-display apparatus can comprise one or multiple public private key pairs. Depending on the implementations, the public private key pairs can be embedded during or after the biometric touch-display apparatus is manufactured. Furthermore, in an embodiment, vendors of biometric touch-display apparatuses can have their own public private key pairs. The public private key pairs embedded in a biometric touch-display apparatus can be certified using the public private key pair associated with a vendor.

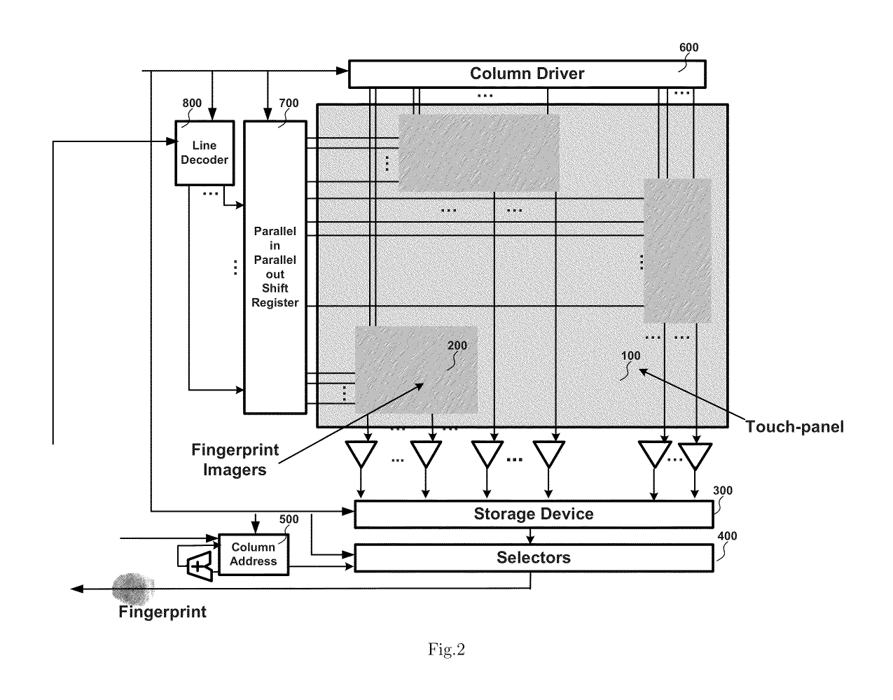

FIG. 2 is a block diagram showing, in one exemplary embodiment of the present invention, the components involved for implementing a biometric touch-display panel.

A biometric touch-display panel can comprise multiple fingerprint imagers (200) that are integrated with a touch panel (100) (e.g., overlayed on top of a touch panel, beneath a touch panel, in-between a touch panel and a display, combined with a touch panel or display panel, integrated together, hybrid device comprising fingerprint imagers and touch panel, hybrid device comprising fingerprint imagers and touch-display panel). Depending on the implementation, a fingerprint imager can cover part of or complete area of a touch panel. A biometric touch-display apparatus can comprise at least one such biometric touch-display panel and use the biometric touch-display panel for collecting fingerprint data.

Furthermore, in an embodiment, a fingerprint imager can be TFT (thin-film transistors) based fingerprint imager. Each TFT fingerprint imager contains a matrix of fingerprint sensing cells, basic sensing unit of a fingerprint imager. A sensing cell can comprise a upper electrode of the capacitor, a metal plate as lower electrode. The TFT fingerprint imagers (200) can be transparent by using transparent materials and transparent TFT fabrication process.

In an additional embodiment, the touch panel can be integrated with an electronic display panel (e.g., OLED displays, liquid crystal display devices such as TFT-LCD, electronic paper display). Or in another embodiment, an electronic display panel can be placed beneath the touch panel.

The TFT fingerprint imagers (200) are controlled by a fingerprint controller (2500). A fingerprint controller can select and activate a fingerprint imager according to pre-determined conditions. In one embodiment, when finger tip is inside the region covered by a fingerprint imager, its location can be recorded. Then the fingerprint controller can select and activate one or multiple fingerprint imagers to capture one or multiple fingerprints according to their locations.

The fingerprint imagers and fingerprint sensing cells can have their unique column addresses and line addresses. The fingerprint control can translate a touch panel location (e.g., position in touch panel X-axis or Y-axis) into a pair of fingerprint imager line address and/or column address. The line address decoder (800) can decode a line address and send the decoding output to a shift register (e.g., parallel-in parallel-out shift register). The shift register (700) can enable one row of fingerprint sensing cells at a time.

In one embodiment, the fingerprint sensing cells in the enabled row can be addressed during a clock cycle and disabled after results of the sensing cells are converted into digital values and fed into the storage devices (physical storage used to temporarily hold data such as latches, flip-flops, or buffers) that are situated at the end of a column (300). Sensed results stored in the storage devices are selected and transmitted to the fingerprint controller.

In one embodiment, a fingerprint controller can compute a pair of column addresses (500) as beginning and end column addresses by the column driver (600). Results stored in the storage devices (300) within the selected columns via the selector (400) are transferred to the controller.

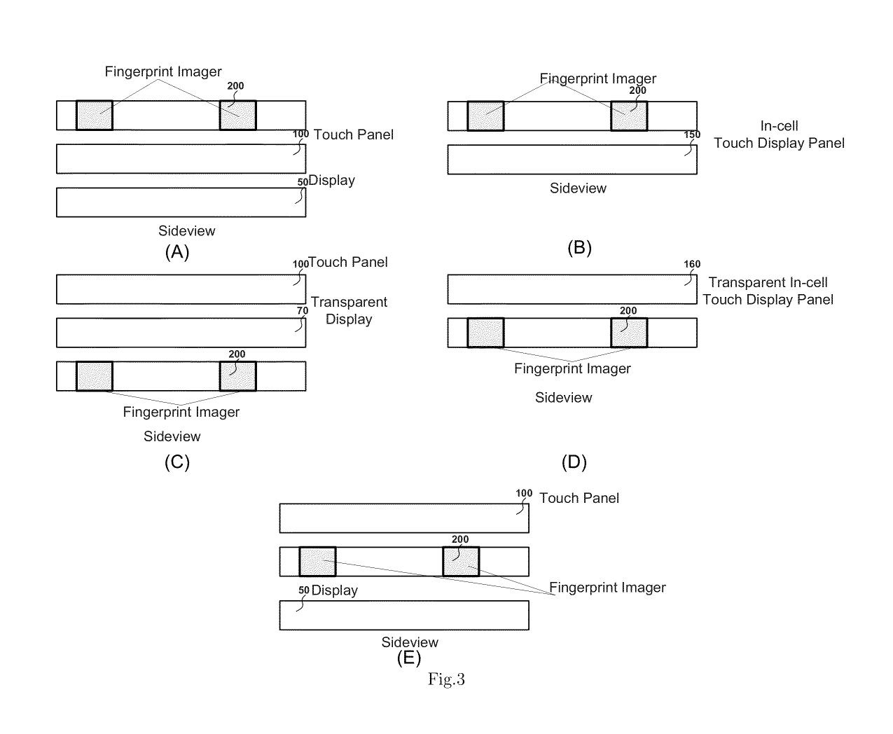

FIG. 3(A), is a block diagram showing, in one exemplary embodiment of the present invention, the structure of fingerprint imager, display, and touch panel. The structure of fingerprint imager, display, and touch panel comprises of three layers: a layer of fingerprint imagers (200), a touch panel (100), and a display (50). The fingerprint imager layer is on the top of the structure and consists of at least one or a plurality of fingerprint imagers; the touch panel is in the middle of the structure; and the display is at the bottom of the structure.

FIG. 3(B), is a block diagram showing, in another exemplary embodiment of the present invention, the structure of fingerprint imager, display, and touch panel. The structure of fingerprint imager, display, and touch panel comprises of two layers: a layer of fingerprint imagers (200) at the top, and an in-cell touch-display panel (150) at the bottom.

An in-cell touch-display panel is a device that integrates the touch panel with an electronic display panel. Manufacturers have developed in-cell touch panels, integrating the production of capacitive sensor arrays in the AMOLED module fabrication process. The fingerprint imager layer is on the top of the structure and comprises at least one or a plurality of fingerprint imagers; and the in-cell touch-display panel is at the bottom of the structure.

FIG. 3(C), is a block diagram showing, in another exemplary embodiment of the present invention, the structure of fingerprint imager, display, and touch panel. The structure of fingerprint imager, display, and touch panel comprises of three layers: a layer of fingerprint imagers (200), a touch panel (100), and a transparent display (70).

A transparent display is a device that can show information with transparent and/or flexible surfaces (e.g. plastics). A transparent display can be made using transparent components (e.g., transparent OLED). A transparent electronic device can be fabricated using transparent electronic process, an emerging science and technology focusing on producing invisible electronic circuitry and/or opto-electronic devices.

In one embodiment, the touch panel is on the top of the structure; the transparent display is in the middle of the structure; and the fingerprint imager layer is at the bottom of the structure with one or a plurality of fingerprint imagers.

FIG. 3(D), is a block diagram showing, in another exemplary embodiment of the present invention, the structure of fingerprint imager, display, and touch panel. The structure of fingerprint imager, display, and touch panel comprises of two layers: a layer of fingerprint imagers (200) and a transparent in-cell touch-display panel (160).

A transparent in-cell touch-display panel is a device integrating a transparent touch panel with a transparent electronic display panel. The in-cell touch-display panel is on the top of the structure; and the fingerprint imager layer is at the bottom of the structure with one or a plurality of fingerprint imagers.

FIG. 3(E), is a block diagram showing, in another exemplary embodiment of the present invention, the structure of fingerprint imager, display, and touch panel. The structure of fingerprint imager, display, and touch panel comprises of three layers: a layer of fingerprint imagers (200), a touch panel (100), and a display (50). The touch panel is on the top of the structure; the fingerprint imager layer is in the middle of the structure with one or a plurality of fingerprint imagers; and the display is at the bottom of the structure.

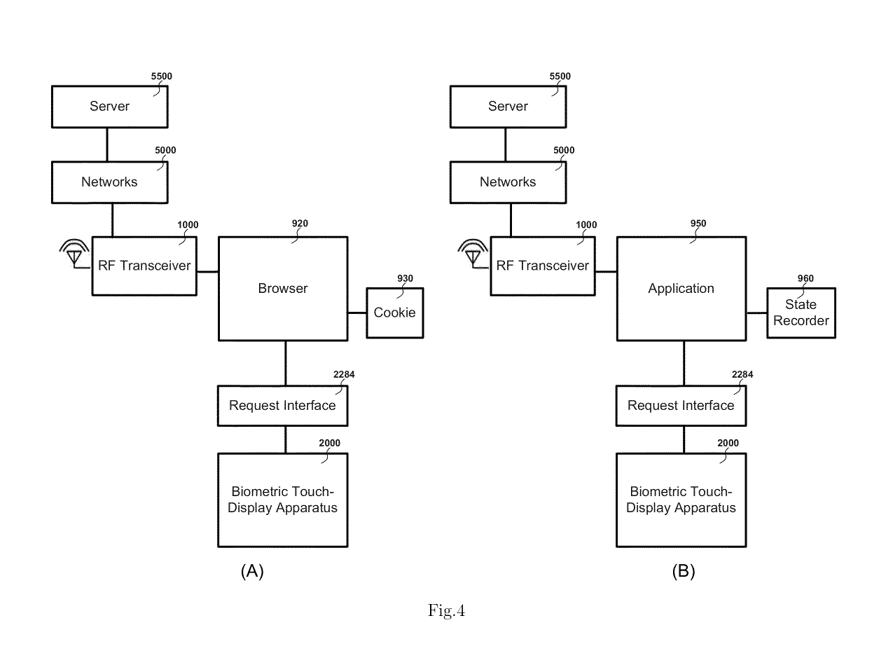

FIG. 4(A) is a block diagram showing, in one exemplary embodiment of the present invention, the components involved for supporting identity management by a computing system.

In accordance with the present invention, the components of implementing identity management include a biometric touch display apparatus (2000), a browser (920) coupled with cookie (930), a request interface (2284) coupling the browser with the biometric touch display apparatus, and one transceiver (1000). Through the system, a user can access one or multiple services provided by a server (5500) over networks (5000) (e.g., wireless network, wired network, cable network).

A server (5500) is a computer system used to run one or more services as a host to serve the needs of clients on the networks. A client is a computing system that can connect to a server over networks. Depending on the computing service, the server could be a database server, or a file server, or a mail server, or a print server, or a web server, or a gaming server, or a server that allows a user to control and/or operate a machine (e.g., vehicle, weapon system, mechanical system, robot, physical entrance), etc. Depending on the implementations, a server can be a real computer or a virtual server. A server can provide access to a resource (e.g., physical resource, virtual resource, logical resource, digital resource) as a service.

A transceiver is a device comprising both transmitter and receiver. A RF Transceiver (1000) uses RF modules (Radio Frequency Module) for data transmission.

A browser (920) is a software application for retrieving, presenting and traversing information resources on the World Wide Web. Examples of web browsers include Chrome, Firefox, Internet Explorer, Opera, Safari, etc. A cookie (930) is usually a small piece of data sent from a website and stored in a user's web browser while the user is browsing a website.

In one embodiment, the server (5500) receives request from the browser (920) over the networks (5000) and sends response back. The response can comprise hyper-text and/or cookie. The browser (920) can store the cookie (930) received from the server (5500). The browser (920) communicates with the biometric touch-display apparatus (2000) by the request interface (2284).

In additional embodiments, the server (5500) can enforce access control to the services that it hosts. For example, it allows an authorized user to access the service. The biometric touch-display apparatus can verify user identity and demonstrate to the server that a service is accessed by an authorized user.

FIG. 4(B) is a block diagram showing, in another exemplary embodiment of the present invention, the components involved for supporting identity management by a computing system.

In accordance with the present invention, the components of implementing identity management include a biometric touch display apparatus (2000), an application (950) coupled with a state recorder (960), a request interface (2284) coupling the application with the biometric touch display apparatus, and one transceiver (1000). Through the system, a user can access one or multiple services provided by a server (5500) over networks (5000) (e.g., wireless network, wired network, cable network).

An application (950) is computer software designed to help a user to perform specific tasks (e.g., a mobile app, a computer software). An application can be executed by a processor. A state recorder (960) is a small piece of data used for recording the status of an application. The recorded data can be stored in an electronic storage.

In one embodiment, the server (5500) receives requests from the application (950) over the networks (5000) and sends responses back. A response can comprise hyper-text and/or other state information. The application (950) can use the state recorder (960) to record the information from the server (5500). The application (950) can communicate with the biometric touch-display apparatus (2000) by the request interface (2284).

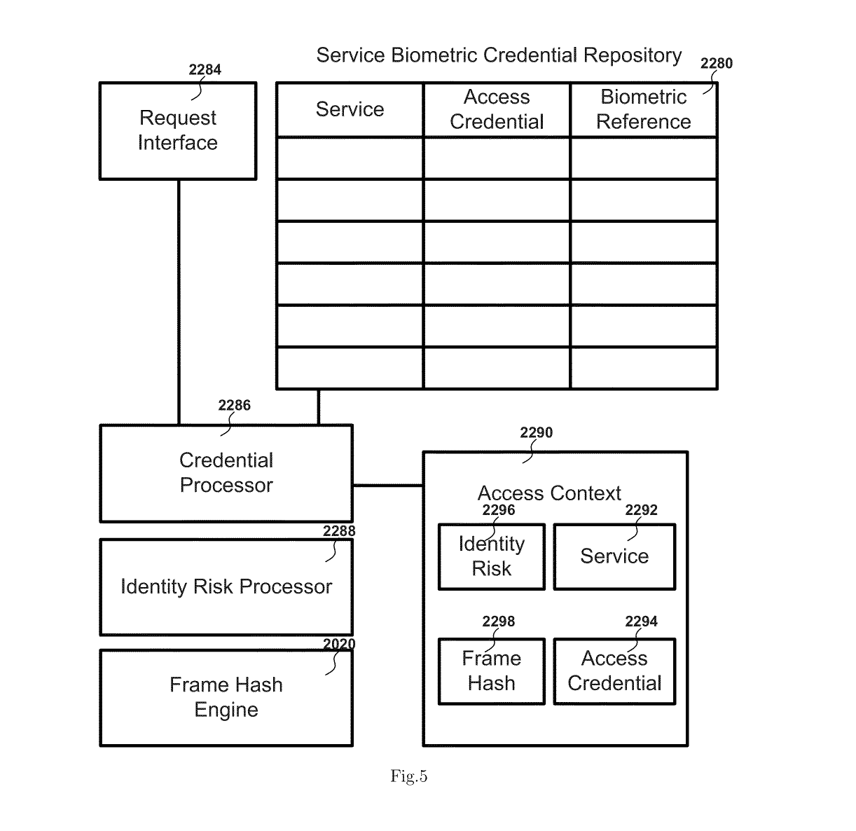

FIG. 5 is a block diagram showing, in one exemplary embodiment of the present invention, the system involved for identity based service context management.

In accordance with the present invention, a service biometric credential repository (2280) is for supporting access to services, and/or supporting identity management. The service biometric credential repository (2280) comprises a collection of service biometric credential records. A service biometric credential record associates a service reference (e.g., URL, universal global id, name, domain, identifier, string, ip address, network address, service access point, a service call interface) with a biometric identity, and/or access credential to the service. A service is usually offered by one or a plurality of servers. The service biometric credential repository can be stored in an electronic storage device (e.g., volatile or non-volatile, on-chip or off-chip).

In accordance with the present invention, a service biometric credential record can comprise, a service reference, an access credential, and a biometric identity.

A server (5500) can enforce access control to the services that it hosts. For example, it allows an authorized user with certain access credential to access the service. An access credential is used to control access to a service and/or other resources in information system. The combination of a user account number or name and a secret password is an example of credentials. There are other forms of documentation of credentials, such as biometrics: fingerprints, voice recognition, retinal scans, facial recognition systems, or X.509, public key certificate, and etc.

A biometric identity comprises an image, or other captured biometric sample, in its original, enhanced or compressed form or a biometric template (original, enhanced, compressed, protected, or encrypted form). Furthermore, a biometric identity can comprise a reference to an image, or reference to other captured biometric sample, in its original, enhanced or compressed form or reference to a biometric template (original, enhanced, compressed, protected, or encrypted form).

In one embodiment, an access context (2290) can comprise, identity risk (2296), a service reference (2292), a frame hash (2298) calculated by a frame hash engine (2020), and an access credential (2294). An access context can be stored in an electronic storage device (e.g., volatile or non-volatile, on-chip or off-chip).

In one embodiment, an access credential (2294) can comprise a public private key pair. A public-private key pair is a cryptographic approach which involves the use of asymmetric key algorithms instead of or in addition to symmetric key algorithms.

In one embodiment, an access credential (2294) can comprise an electronic access token. An electronic access token is a token that contains the security information for a login session and identifies the user, the user's groups, or the user's privileges.

In one embodiment, an access credential (2294) can comprise a biometric template or reference to a biometric template. A biometric template is a digital reference of distinct characteristics that have been extracted from a biometric sample. Templates are used during the biometric authentication process.

In one embodiment, the service biometric credential repository (2280) stores a collection of service biometric credential records in a persistent electronic storage.

In one embodiment, a credential processor (2286) is a processing component used to provide access credential to a server. It retrieves an access credential from a service biometric credential record that matches with the captured biometric of a user. A credential processor can receive request from a request interface (2284).

In one embodiment, results of fingerprint match can be used for measuring identity risk (2296). Identity risk (2296) quantitatively measures the likelihood of identity fraud. In one implementation, identity risk (2296) can be defined as the number of times that fingerprints can be captured and verified out of certain number of touches from a user.

In another implementation, identity risk (2296) can be defined as number of times fingerprints are captured and verified within a time window. In additional embodiments, identity risk (2296) can be defined as a function of time, statistics of touches, and statistics of fingerprint match results. Depending on the embodiments, one can define a computational way for calculating identity risk (2296). However, the scope of the invention should not be limited to specific implementation of how identity risk (2296) is computed.

In one embodiment, identity risk (2296) is calculated and/or updated by an identity risk processor (2288) or a computing system. In one implementation, an identity risk processor (2288) or a computing system records recent touch events and/or fingerprint match results. It computes a new identity risk (2296) value based on the recorded data.

Moreover, in one embodiment, fingerprint match results can be used for updating access context (2290) by the biometric touch-display apparatus. Additionally, the access context (2290) can comprise a collect of attributes that includes identity risk (2296).

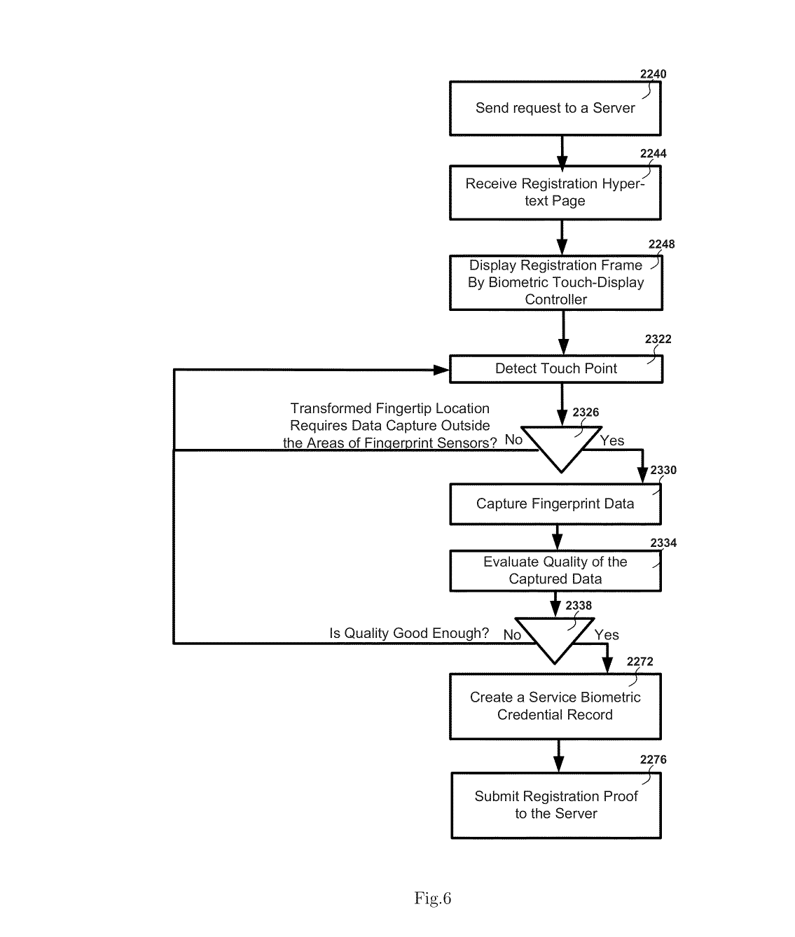

FIG. 6 is a flowchart showing, in one exemplary embodiment of the present invention, the process involved for associating fingerprints with service access credentials by using a biometric touch-display apparatus.

In accordance with the present invention, a computing system (e.g., laptop, desktop, tablet, notebook, PDA, mobile phone, mobile Internet device, handheld gaming device, Kiosk) can associate fingerprints with service access credentials using a biometric touch-display apparatus. The computing system can send a request to a server over networks (2240). In response to the request, the server sends a registration hyper-text page to the computing system.

A registration hyper-text page is a hyper-text page used for registration. After a user is registered, the user can access the service provided by the server. A service biometric credential record associates a service reference (e.g., URL, universal global id, name, domain, identifier, string, ip address, network address, service access point, an service call interface) with a biometric identity, and/or access credential to the service. The service biometric credential record can be stored in an electronic storage device (e.g., volatile or non-volatile, on-chip or off-chip).

In one embodiment, the request can be sent (2240) from a browser executed by the computing system.

In another embodiment, the request can be sent (2240) from an application executed by the computing system.

The registration hyper-text page returned from the server is rendered by the computing system (2248). Apart from text, hyper-text may contain widget, or menus, or buttons, or tables, or images, or video clips, or other presentational devices.

A user can interact with the displayed hyper-text by touching the biometric touch-display panel. For example, touch inputs from a user can be converted into touch gestures (e.g., zoom in, zoom out, left flick, right flick, pan, roll, drag, spread, pinch, spread).

A biometric identity is established when a biometric sample(s) is used to identify a user. In accordance with the present invention, the biometric is fingerprint. A fingerprint is formed from the skin uneven surface of ridges and valleys. In one embodiment, when recorded by a fingerprint imager, a fingerprint appears as a series of dark lines that represents the high, peaking portion of the ridged skin. The white space is the valley (the low, shallow portion of the ridged skin) between the ridges.

In an embodiment, when a user touches the touch panel, a touch event will be generated and touch location (e.g., touch panel coordinate) will be recorded (2322). When the controller gets the touch event and its touch panel coordinate, it can calculate the corresponding fingerprint imager coordinate according to fingerprint imager's location mapped to the touch panel space (2330). If the calculated fingerprint imager coordinate is within the data capture range of one or multiple fingerprint imagers, the controller will enable these specific fingerprint imagers and capture the fingerprint by selecting these rows and columns surrounding the touch point (2326).

In additional embodiments, for captured fingerprint, before it is admitted, its quality can be evaluated (2334). Low quality finger-print data can be discarded. The admitted fingerprint will be used for creating a service biometric credential record. Depending on the implementations, fingerprint recognition can be applied.

In an embodiment, a biometric touch-display apparatus or computing system creates a service biometric credential record by associating a service reference (e.g., URL, universal global id, name, domain, identifier, string, ip address, network address, service access point, an service call interface) with a biometric identity, and/or an access credential to the service (2272). A biometric identity can comprise an image, or other captured biometric sample, in its original, enhanced or compressed form or a biometric template. Furthermore, a biometric identity can comprise a reference to an image, or reference to other captured biometric sample, in its original, enhanced or compressed form, or reference to a biometric template.

In furthermore embodiments, a biometric touch-display apparatus or a computing system can create an access credential that can be used to control access to a service and/or other resources. Depending on the implementations, an access credential can comprise, a public private key pair generated by the biometric touch-display apparatus or computing system, or a password generated by the biometric touch-display apparatus or computing system, or a secret encryption key (e.g. symmetric encryption key) generated by the biometric touch-display apparatus or computing system, or a biometric identity, etc.

In an additional embodiment, a biometric touch-display apparatus or a computing system can certify the access credential and/or the service biometric credential record. Depending on the implementations, a biometric touch-display apparatus can use its embedded private key to certify the access credential and/or the service biometric credential record.

Furthermore, in an embodiment, the computing system can submit a registration proof to the server (2276). The registration proof can be sent by the computing system to the sever using its transceiver. Depending on the embodiments, a registration proof can be submitted using hap, or TCP/IP, or any network protocol, or any remote procedure call interface.

A registration proof can comprise part of the access credential (e.g., public key, password, secret key), or complete access credential, or data derived from the access credential (e.g., data computed based on part of or complete access credential). Depending on the implementations, a server can store the received access credential in its database.

In one embodiment, the submitted registration proof can comprise a hash of the pixel values of the displayed registration frame.

In additional embodiments, the submitted registration proof can comprise a nonce encrypted by the biometric touch-display apparatus or the computing system. Depending on the implementations, the nonce can be sent from the server. Furthermore, in an embodiment, the nonce can be encrypted by the private key embedded in a biometric touch-display apparatus. Or in an alternative embodiment, the nonce can be encrypted by a key taken from the access credential. For example, if the access credential comprises a public private key pair, the nonce can be encrypted using the private key. Alternatively, if the access credential comprises a secret key, the nonce can be encrypted using the secret key.

In additional embodiments, the submitted registration proof can be encrypted by the biometric touch-display apparatus or the computing system. Encryption can be applied to part of or the complete registration proof.

In further embodiments, the submitted registration proof can be signed with digital signature or message authentication code by the biometric touch-display apparatus or the computing system.

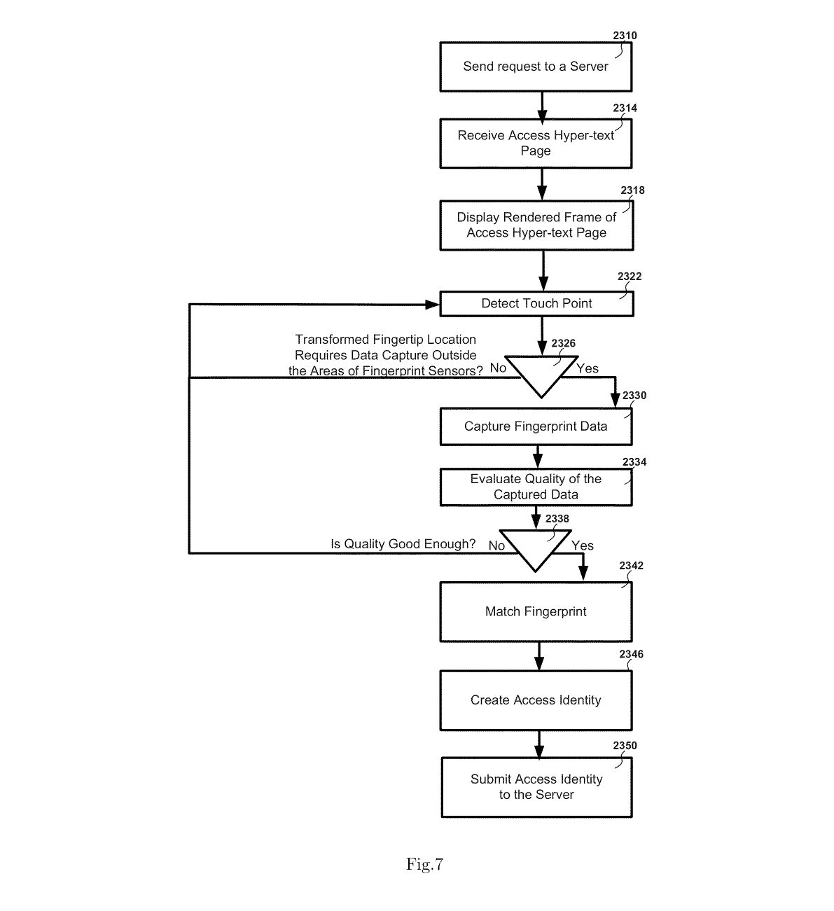

FIG. 7 is a flowchart showing, in one exemplary embodiment of the present invention, the process of creating a session when a service is accessed using a biometric touch-display apparatus.

In accordance with the present invention, when a user wants to access a service using a computing system (e.g., laptop, desktop, tablet, notebook, PDA, mobile phone, mobile Internet device, handheld gaming device, Kiosk), the computing system can send a request to the server over networks (2310). In response to the request, the server sends an access hyper-text page to the computing system (2314) (e.g., a login page, a page for establishing a login session, a page for creating a connection).

In one embodiment, the request can be sent from a browser executed by the computing system.

In another embodiment, the request can be sent from an application executed by the computing system.

The hyper-text page returned from the server is rendered by the computing system with references (hyperlinks) to other text that a user can access by touching the biometric touch-display panel. Apart from text, hyper-text may contain widget, or menus, or buttons, or tables, or images, or video clips, or other presentational devices (2318).

A user can interact with the displayed hyper-text by touching the biometric touch-display panel. For example, touch inputs from the user can be converted into touch gestures (e.g., zoom in, zoom out, left flick, right flick, pan, roll, drag, spread, pinch, spread).

In an embodiment, when a user touches the touch panel, a touch event will be generated and touch location (e.g., touch panel coordinate) will be recorded. When the controller gets the touch event and its touch panel coordinate, it can calculate the corresponding fingerprint imager coordinate according to fingerprint imager's location mapped to the touch panel space (2322). If the calculated fingerprint imager coordinate is within the data capture range of one or multiple fingerprint imagers (2326), the controller will enable these specific fingerprint imagers and capture the fingerprint by selecting these rows and columns surrounding the touch point (2330).

In additional embodiments, for a captured fingerprint, before it is admitted for fingerprint recognition, its quality can be evaluated (2334). Low quality fingerprint data can be discarded. Fingerprint recognition will be applied to the admitted fingerprint by the biometric processor (2338).

An access hyper-text page can contain one or a plurality of hyper-text links, or one or a plurality of buttons. If one of the hyper-text links or buttons is selected by a user, the fingerprint will be captured and an access identity will be created.

An access identity can comprise a collection of attributes. In one embodiment, an access identity can comprise access credential associated with a user and a service. Access credential is used for controlling accesses to service and/or resources. Access credential includes but not limited to, password, biometric identity (e.g., fingerprint template or reference to fingerprint template), public private key pair, secret key, data encrypted using a private key, data encrypted using a secret key shared between a server and a biometric touch-display apparatus or a computing system.

In an embodiment, the access credential associated with a service and a user is stored in a service biometric credential repository. When an access identity is created, the relevant credential information (e.g., password, biometric identity, private key, secret key) is retrieved from the service biometric credential repository (2346) based on the captured fingerprint data.

In an embodiment, the computing system can submit the access identity to the server. The access identity can be sent by the computing system to the sever using its transceiver (2350). Depending on the embodiments, the access identity can be submitted using hap, or TCP/IP, or any network protocol, or any remote procedure call interface.

In one embodiment, the submitted access identity can comprise a frame hash. The frame hash engine or the computing system can compute a hash of the pixel values of the displayed frame corresponding to the access hyper-text page.

In additional embodiments, the submitted access identity can comprise a nonce encrypted by the biometric touch-display apparatus or the computing system. Depending on the implementations, the nonce can be sent from the server. Furthermore, in an embodiment, the nonce can be encrypted by the private key embedded in a biometric touch-display apparatus or a computing system. Or in an alternative embodiment, the nonce can be encrypted by a key taken from the access credential. For example, if the access credential comprises a public private key pair, the nonce can be encrypted using the private key. Alternatively, if the access credential comprises a secret key, the nonce can be encrypted using the secret key.

In additional embodiments, the submitted access identity can comprise a session key (e.g., secret key shared between the server and the biometric touch-display apparatus or the computing system). The session key can be encrypted.

In further embodiments, the submitted access identity can be signed with digital signature or message authentication code by the biometric touch-display apparatus or the computing system.

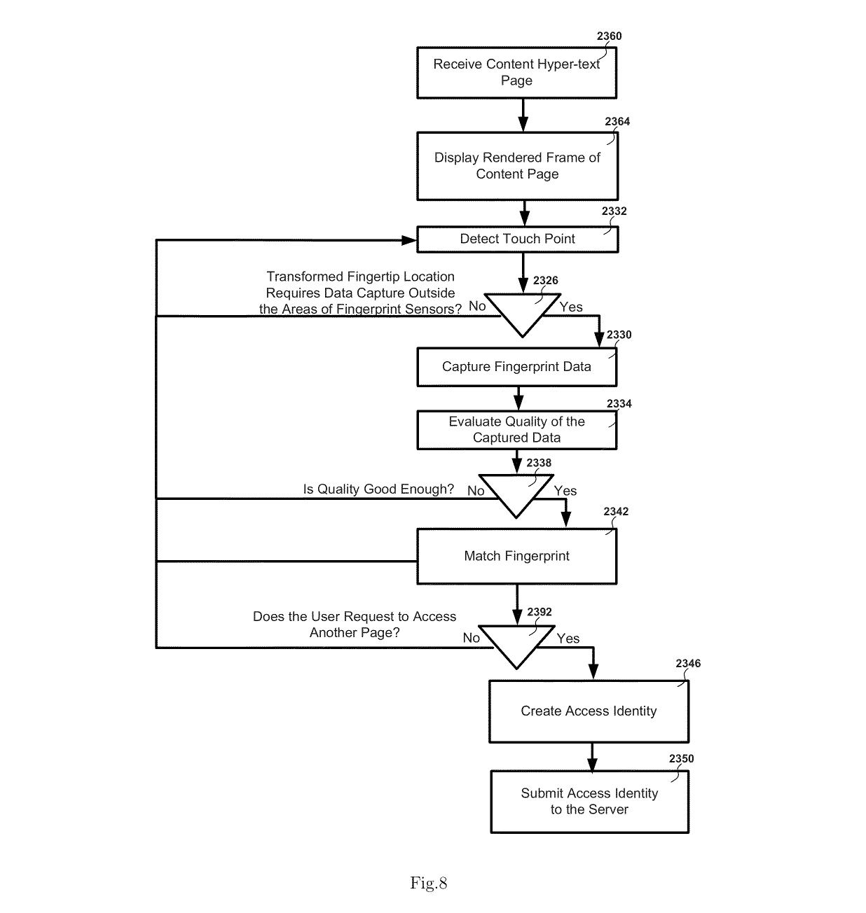

FIG. 8 is a flowchart showing, in one exemplary embodiment of the present invention, the process of continuous identity management during access of service contents.

In accordance with the present invention, after a service session is created between a computing system (e.g., laptop, desktop, tablet, notebook, PDA, mobile Internet device, mobile phone, handheld gaming device, Kiosk) and a server, the computing system can send request to the server over networks. In response to the request, the server sends content hyper-text page to the computing system.

In one embodiment, the request can be sent from a browser executed by the computing system.

In another embodiment, the request can be sent from an application executed by the computing system.

The hyper-text page returned from the server is rendered by the computing system with references (hyperlinks) to other text that a user can access by touching the biometric touch-display panel (2360). Apart from text, hyper-text may contain widget, or menus, or buttons, or tables, or images, or video clips, or other presentational devices. Depending on the implementations, a hyper-text can allow a user to control resources (e.g., physical resource, logical resource, financial transaction information) through touch a biometric touch-display apparatus. For example, a user can control or operate a remote physical resource (e.g., a machine, a weapon, a vehicle, a plane, an entrance) by interacting with the displayed hyper-text content. The capability can be offered to the user as a service.

A user can interact with the displayed hyper-text by touching the biometric touch-display panel (2364). For example, touch inputs from the user can be converted into touch gestures (e.g., zoom in, zoom out, left flick, right flick, pan, roll, drag, spread, pinch, spread), used for modifying the displayed hyper-text, and/or control a resource.

In an embodiment, when a user touches the touch panel, a touch event will be generated and touch location (e.g., touch panel coordinate) will be recorded (2332). When the controller gets the touch event and its touch panel coordinate, it can calculate the corresponding fingerprint imager coordinate according to fingerprint imager's location mapped to the touch panel space (2330). If the calculated fingerprint imager coordinate is within the data capture range of one or multiple fingerprint imagers, the controller will enable these specific fingerprint imagers and capture the fingerprint by selecting these rows and columns surrounding the touch point (2326).

In additional embodiments, for a captured fingerprint, before it is admitted for fingerprint recognition, its quality can be evaluated (2334). Variety of reasons may lead to poor fingerprint quality (e.g. move too fast or press too soft). Low quality finger-print data can be discarded. Fingerprint recognition will be applied to the admitted fingerprint by the biometric processor (2338).

In one embodiment, results of fingerprint match will be used for measuring identity risk (2342). Identity risk quantitatively measures the likelihood of identity fraud. In one implementation, identity risk can be defined as out of certain number of touches from a user, the number of times that fingerprints can be captured and/or verified. In another implementation, identity risk can be defined as within a time window, number of times fingerprints are captured and/or verified. In additional embodiments, identity risk can be defined as a function of time, statistics of touches, and statistics of fingerprint match results. Depending on the embodiments, one can define many different ways for calculating identity risk. However, the scope of the invention should not be limited to specific implementation of how identity risk is computed.

In one embodiment, identity risk is calculated and updated by an identity risk processor or a computing system. In on implementation, the identity risk processor or the computing system records recent touch events and fingerprint match results. It computes a new identity risk value based on the recorded data.

In one embodiment, fingerprint match results can be used for updating access context by the biometric touch-display apparatus or the computing system (2392). Additionally, the access context can comprise a collect of attributes that include identity risk.

In further embodiments, the frame hash engine or the computing system can compute a hash of the pixel values of the displayed frame corresponding to the content hyper-text page. In additional embodiments, the computed hash value is stored as part of the access context.

A content hyper-text page can contain one or a plurality of hyper-text links. If one of the hyper-text links or one of the presentation devices (e.g., widget, button, menu) is selected by a user, the biometric touch-display apparatus or the computing system can create an access identity. Access identity comprises a collection of attributes. In one embodiment, an access identity can comprise access credential associated with a user and a service. Access credential is used for controlling accesses to a service and/or a resource. Access credential includes but not limited to, password, biometric identity (e.g., fingerprint template or reference to fingerprint template), public private key pair, secret key, data encrypted using a private key, data encrypted using a secret key shared between a server and a biometric touch-display apparatus or a computing system.

In an embodiment, the access credential associated with a service and a user is stored in a service biometric credential repository. When an access identity is created, the relevant credential information (e.g., password, biometric identity, private key) is retrieved from the service biometric credential repository (2346).

Furthermore, in an embodiment, the computing system can submit the access identity to the server. The access identity can be sent by the computing system to the sever using its transceiver (2350). Depending on the embodiments, the access identity can be submitted using hap, or TCP/IP, or any network protocol, or any remote procedure call interface.

In one embodiment, the submitted access identity can comprise a frame hash. In additional embodiments, the submitted access identity can comprise a nonce encrypted using a session key (shared between the biometric touch-display apparatus or the computing system and the server) or a private key retrieved from the service biometric credential repository. Or in an alternative embodiment, the nonce can be encrypted by a key taken from the access credential. For example, if the access credential comprises a public private key pair, the nonce can be encrypted using the private key. Alternatively, if the access credential comprises a secret key or a session key, the nonce can be encrypted using the secret key or the session key. Depending on the implementations, the nonce can be sent from the server.

In further embodiments, the submitted access identity can be signed with digital signature or message authentication code by the biometric touch-display apparatus or the computing system.

In an embodiment where hyper-text is handled by a browser, the access identity can be submitted as values of hap cookie. Furthermore, part of or whole of the access identity can be encrypted.

It should be understood that there exists implementations of other variations and modifications of the invention and its various aspects, as may be readily apparent to those of ordinary skill in the art, and that the invention is not limited by the specific embodiments described herein.

What is claimed is:

1. A biometric touch-display apparatus comprises,
at least one crypto processor that can perform cryptography functions;
at least one biometric processor that can enroll and/or match fingerprints;
at least one display repeater and/or display controller coupled with a display device;
at least one interconnect fabric that provides shared communications;
at least one electronic storage device; and
at least one touch-panel controller that can receive input from a touch panel and determine the location of the touch;

2. The biometric touch-display apparatus in claim 1 further comprising at least one host interface that can couple said biometric touch-display apparatus with a host computing system wherein said host computing system comprises a transceiver.

3. The biometric touch-display apparatus in claim 1 further comprising at least one frame hash engine coupled with the display repeater or the display controller wherein said frame hash engine can compute a hash from pixel values of a frame displayed by the biometric touch-display apparatus.

4. The biometric touch-display apparatus in claim 1 further comprising at least one fingerprint controller wherein said fingerprint controller is coupled with at least one or a plurality of fingerprint imagers, and said fingerprint controller can read inputs from the coupled fingerprint imager or fingerprint imagers.

5. The biometric touch-display apparatus in claim 1 further comprising at least one biometric touch-display panel wherein said biometric touch-display panel comprises,
at least one touch-display panel or touch-panel;
at least one or a plurality of fingerprint imagers wherein said fingerprint imager or fingerprint imagers are integrated with said touch-display panel or said touch-panel.

6. A method of associating fingerprint with service access credential by a computing system and/or a biometric touch-display apparatus wherein said biometric touch-display apparatus comprises, at least one crypto processor that can perform cryptography functions, at least one biometric processor that can enroll and/or match fingerprints, at least one display repeater and/or display controller coupled with an electronic display device, at least one interconnect fabric that provides shared communications, at least one electronic storage device, and at least a touch-panel controller that can sense data from a touch panel and determine the location of touch input, and said method comprises,
sending a request to a server by the computing system using a transceiver;
receiving a registration hyper-text page from the server by the computing system;
displaying said registration hyper-text page on a display device coupled with the biometric touch-display apparatus;
capturing fingerprint biometric by the biometric touch-display apparatus;
creating a service biometric credential record wherein said service biometric credential record associates access to at least one service with the captured biometric identity and/or an access credential; and
submitting a registration proof to the server using a transceiver wherein said registration proof comprises part of the access credential or complete access credential.

7. The method of creating a service biometric credential record in claim 6 further comprising, generating an access credential wherein said access credential comprises a public-private key pair.

8. The method of creating a service biometric credential record in claim 6 further comprising, generating an access credential wherein said access credential comprises an electronic access token.

9. The method of creating a service biometric credential record in claim 6 further comprising, generating as access credential wherein said access credential comprises a biometric template or reference to a biometric template.

10. The method in claim 6 further comprising, storing the created service biometric credential record to a service biometric credential repository wherein said service biometric credential repository stores a collection of service biometric credential records in a persistent electronic storage.

11. The method of capturing fingerprint biometric by the biometric touch-display apparatus in claim 6 further comprising,
determining touch panel coordinate of a touch by the touch panel controller;
translating the touch panel coordinate into line and column fingerprint imager addresses;
activating at least one fingerprint imager according to the line and column addresses; and
capturing fingerprint by the activated fingerprint imager.

12. The method in claim 6 further comprising, computing a hash of the pixel values of the displayed frame wherein said displayed frame is a rendered display frame of the registration hyper-text page.

13. The method in claim 6 further comprising, encrypting at least one part of the registration proof by the crypto processor.

14. A method of managing access identity for services wherein a service is accessed from a computing system and/or a biometric touch-display apparatus wherein said biometric touch-display apparatus comprises, at least one crypto processor that can perform cryptography functions, at least one biometric processor that can enroll and/or match fingerprints, at least one display repeater and/or display controller coupled with an electronic display device, at least one interconnect fabric that provides shared communications, at least one electronic storage device; and at least a touch-panel controller that can sense data from a touch panel and determine the location of the touch; said method comprises,
receiving a hyper-text page from the server by the computing system;
displaying said hyper-text page on a display device coupled with the biometric touch-display apparatus;
capturing fingerprint biometric by the biometric touch-display apparatus;
matching the captured fingerprint by the biometric processor of the biometric touch-display apparatus; and
updating access context by the biometric touch-display apparatus wherein said access context is stored in an electronic storage device integrated with or coupled with the biometric touch-display apparatus.

15. The method in claim 14 further comprising, computing an identity risk by an identity risk processor wherein said identity risk processor is coupled with or integrated with the biometric processor.

16. The method in claim 14 wherein the hyper-text page is an access page, further comprising,
creating an access identity by the biometric touch-display apparatus or the computing system wherein said access identity comprises part of access credential or complete access credential wherein said access credential matches with the captured fingerprint biometric and/or said access credential is retrieved from the service biometric credential repository; and
submitting the access identity to the server using a transceiver by the computing system.

17. The method in claim 14 further comprising, computing a hash of the pixel values of the displayed frame wherein said displayed frame is a rendered display frame of the access hyper-text page.

18. The method in claim 14 wherein the hyper-text page is a content page wherein said content page contains at least one or a plurality of hyper-text links, and one of the hyper-text links is selected, further comprising,
creating an access identity by the biometric touch-display apparatus or the computing system wherein said access identity comprises part of access credential or complete access credential wherein said access credential matches with the captured fingerprint biometric and/or said access credential is retrieved from the service biometric credential repository; and
submitting the access identity to the server using a transceiver by the computing system.

19. The method in claim 18 further comprising, submitting identity risk to the server using a transceiver by the computing system.

20. The method of submitting the access identity to the server in claim 18 further comprising, submitting the access identity as hap cookie fields.
